(19) United States
(12) Patent Application Publication
(10) Pub. No.: US 2026/0264635 A1
(43) Pub. Date: Sep. 10, 2026

(54) Adjustable Bumper Lift System for Trucks and SUVs to Align with Body Lift Kits

(71) Applicant: Dennis Duffy Mahoney, Sandpoint, ID (US)

(72) Inventor: Dennis Duffy Mahoney, Sandpoint, ID (US)

(21) Appl. No.: 19/070,454

(22) Filed: Mar. 4, 2025

(51) Int. Cl. B60R 19/38; B62D 65/16

(52) U.S. Cl. CPC B60R 19/38; B62D 65/16

(57) ABSTRACT

The present invention relates to a bumper lift system for trucks and SUVs, designed to elevate the front and rear bumpers to align with an installed body lift kit. The system comprises a top block positioned above the vehicle's frame horn and a lower block positioned below the frame horn, both of which are dimensioned to match the height of the body lift kit. The blocks are secured using high-strength through-bolts that sandwich the frame horn, providing a structurally stable and durable mounting configuration. The invention restores proper bumper alignment, eliminates the gap created by a body lift modification, and maintains the vehicle's aesthetic continuity and functional integrity. The system is designed for easy installation without requiring permanent modifications to the vehicle's frame, making it an ideal solution for off-road enthusiasts and vehicle customization professionals.

### BACKGROUND OF THE INVENTION

### Field of Invention

The present invention relates to automotive modification accessories, specifically to bumper lift systems for trucks and sport utility vehicles (SUVs). More particularly, the invention pertains to a structural lifting apparatus designed to elevate the front and rear bumpers of a vehicle to align with an installed body lift kit, thereby maintaining a uniform and aesthetically consistent vehicle profile while accommodating larger wheels and tires.

### BRIEF SUMMARY OF THE INVENTION

The present invention provides a bumper lift system designed to elevate the front and rear bumpers of a truck or SUV to match the height of an installed body lift kit. The system comprises a top block and a lower block, each corresponding in height to the body lift, which are secured to the vehicle's frame horns using through-bolts. By sandwiching the frame between these blocks, the bumper is raised to a position that restores visual alignment with the lifted body, eliminating the gap created by the body lift modification. The invention ensures a secure, durable, and structurally stable solution for maintaining both the functionality and aesthetics of modified vehicles.

### BRIEF DESCRIPTION OF THE FIGURES

FIG. 1 is a perspective view of the bumper lift system, illustrating the general structure of the device.

FIG. 2 is an alternate perspective view of the bumper lift system, showing additional details of the block design and mounting holes.

FIG. 3 is a side view of the bumper lift system, depicting the relative positioning of the through-holes used for securing the device to the vehicle's frame horn.

### DETAILED DESCRIPTION

The present invention is a bumper lift system designed to elevate the front and rear bumpers of a truck or SUV to align with an installed body lift kit. When a body lift kit is applied to a vehicle, the body is raised relative to the frame, creating a noticeable gap between the bumper and the body. This gap not only affects the vehicle's aesthetic appeal but may also interfere with bumper functionality, including crash impact zones, approach and departure angles, and the proper alignment of auxiliary components such as tow hooks, grille guards, and parking sensors. The invention provides a structurally sound and reliable solution to reposition the bumper to match the new body height, restoring the vehicle's original proportions while ensuring stability and durability under normal driving conditions and off-road use.

The bumper lift system consists of two primary lifting components: a top block and a lower block, both designed to match the height of the installed body lift kit. These blocks serve as structural spacers, repositioning the bumper mounting points on the vehicle's frame horns. The frame horns are the forward-most and rear-most extensions of the vehicle's frame to which bumpers are traditionally mounted. The top block is positioned above the frame horn and functions as a raised mounting surface for the bumper, ensuring that its new position aligns with the lifted body. The lower block is positioned beneath the frame horn, reinforcing the mounting structure while distributing the applied loads evenly. Both blocks are precision-machined from high-strength metal, such as steel or aluminum, to provide a durable, load-bearing solution capable of withstanding vibrations, dynamic forces, and external impacts.

The system is secured using high-strength through-bolts that pass through the top block, frame horn, and lower block, effectively sandwiching the frame horn between the two lifting components. These fasteners are engineered to meet automotive-grade strength standards, ensuring that the bumper remains firmly secured even under harsh driving conditions. Once installed, the bumper is elevated to its correct height relative to the modified vehicle body, eliminating the gap created by the body lift. This configuration ensures that the bumper retains its intended structural and functional characteristics, including proper positioning for crash protection, optimal clearance for larger tires, and compatibility with existing vehicle accessories.

The installation process involves removing the factory bumper mounting bolts and inspecting the frame horns for proper fitment. The top block is then positioned on the upper surface of the frame horn, while the lower block is aligned beneath it. The blocks are designed to conform to the vehicle's factory mounting contours, providing a precise and secure fit. Through-bolts are inserted through pre-drilled holes in the blocks and frame horn, and they are then torqued to the manufacturer's specified standards to ensure a tight and stable connection. Once secured, the bumper is reinstalled at its elevated position, aligning seamlessly with the modified vehicle body.

This invention addresses a significant gap in the market, as no commercially available solutions currently exist to lift a vehicle's bumper following a body lift modification. By providing a simple yet highly effective method to reposition the bumper, this system enhances both the aesthetic appeal and functionality of modified trucks and SUVs. It is particularly beneficial for off-road enthusiasts, vehicle customization professionals, and individuals seeking a durable and reliable means of aligning bumpers with lifted vehicle bodies. The design allows for straightforward installation with minimal modifications to the existing frame structure, making it a practical and user-friendly solution for vehicle owners looking to maintain the structural integrity and visual cohesion of their modified trucks and SUVs.

### DETAILED DESCRIPTION OF FIGURES

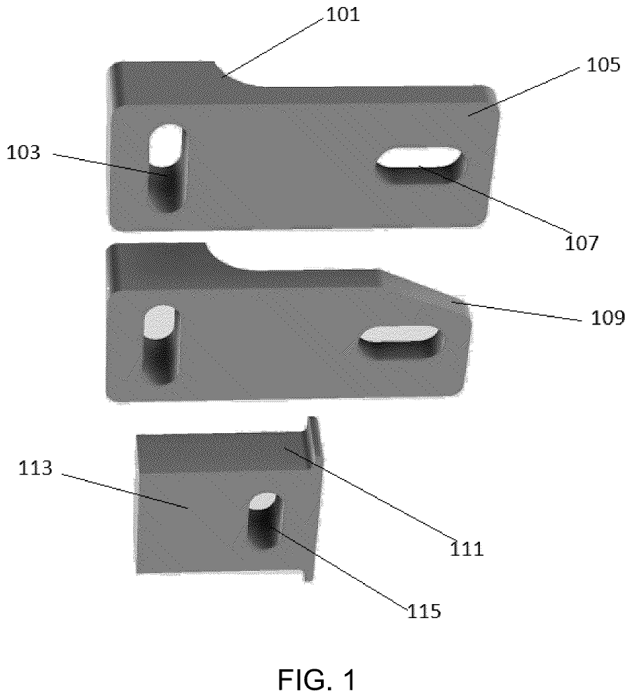

FIG. 1 illustrates a perspective view of the bumper lift system, which consists of a rectangular structural block with a series of pre-drilled through-holes. The block is designed to be positioned either above or below the vehicle's frame horn, depending on its placement within the lift system. The through-holes are strategically located to allow high-strength fasteners to secure the block to the vehicle's frame, creating a stable mounting interface for the bumper. The figure provides an overview of the device's general geometry and mounting features.

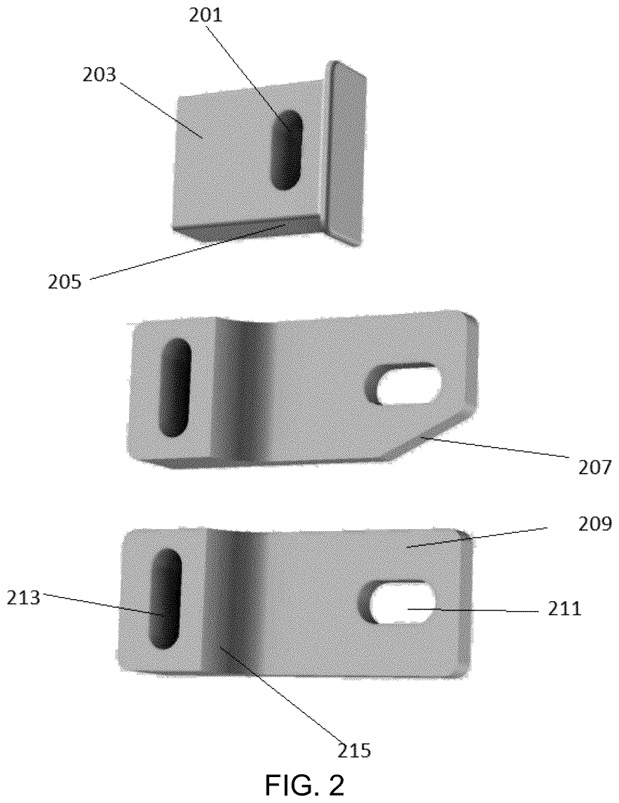

FIG. 2 presents an alternate perspective view of the bumper lift system, offering additional visibility into the structural design and positioning of the mounting holes. The figure highlights the uniformity of hole placement, which ensures proper alignment with the vehicle's frame horn and corresponding fasteners. The perspective view also emphasizes the block's thickness and overall dimensions, which are engineered to match the height of the installed body lift kit. This view further clarifies how the component interacts with the vehicle's frame structure.

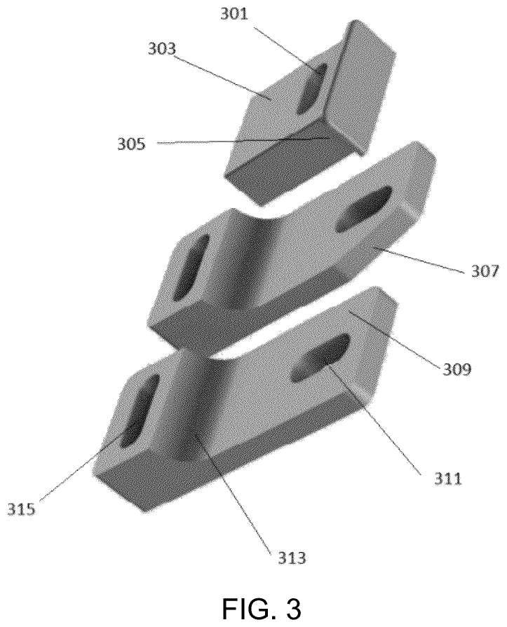

FIG. 3 provides a side view of the bumper lift system, showcasing the arrangement and spacing of the through-holes in relation to the block's height. This view is particularly useful for understanding the alignment of the fasteners and how they interact with both the frame horn and the bumper mounting points. The figure also depicts the relative thickness of the block, ensuring that it maintains sufficient structural integrity to withstand applied loads and environmental stressors.

What is claimed is:

1. A bumper lift system for a vehicle, the system comprising:
a. top block configured to be positioned above a frame horn of the vehicle, the top block having a height substantially equal to a body lift installed on the vehicle;
b. a lower block configured to be positioned below the frame horn of the vehicle, the lower block having a height substantially equal to the body lift installed on the vehicle; and
c. at least one fastener assembly configured to extend through the top block, the frame horn, and the lower block, securing the blocks in place and elevating the bumper relative to the vehicle's frame.

2. The bumper lift system of claim 1, wherein the top block and lower block are made from a high-strength material selected from the group consisting of steel, aluminum, or reinforced composite material.

3. The bumper lift system of claim 1, wherein the top block and lower block are precision-machined to conform to the contours of the frame horn, ensuring a secure and stable attachment.

4. The bumper lift system of claim 1, wherein the fastener assembly includes at least one high-strength bolt configured to pass through pre-drilled holes in the top block, frame horn, and lower block.

5. The bumper lift system of claim 4, wherein the high-strength bolt is an automotive-grade bolt selected from the group consisting of SAE Grade 8 bolts, ISO Class 10.9 bolts, or equivalent high-tensile strength fasteners.

6. The bumper lift system of claim 1, wherein the system is configured to be removably installed without requiring permanent modifications to the vehicle's frame.

7. The bumper lift system of claim 1, wherein the top block and lower block are coated with a protective finish selected from the group consisting of powder coating, anodization, or zinc plating, thereby providing corrosion resistance and durability.

8. The bumper lift system of claim 1, wherein the system is adapted for use with a truck or SUV that has been modified with a body lift kit.

9. The bumper lift system of claim 1, wherein the installation of the system restores the bumper alignment to match the elevated vehicle body while maintaining the bumper's structural integrity and functional positioning.

10. A method for lifting a vehicle's bumper to align with a body lift kit, the method comprising:
a. removing the vehicle's bumper from its original mounting position on the frame horn;
b. positioning a top block on an upper surface of the frame horn, the top block having a height equal to the body lift installed on the vehicle;
c. positioning a lower block on a lower surface of the frame horn, the lower block
d. having a height equal to the body lift installed on the vehicle;
e. inserting at least one fastener assembly through the top block, frame horn, and lower block to secure the blocks in place;
f. torquing the fastener assembly to manufacturer-specified standards to ensure a secure and stable connection; and
g. reattaching the bumper at its elevated position, aligning it with the lifted body of the vehicle.

11. The method of claim 10, wherein the top block and lower block are fabricated using CNC machining for precision fitment.

12. The method of claim 10, wherein the fastener assembly includes thread-locking compounds or lock washers to prevent loosening under vehicle vibration and dynamic loads.

13. The method of claim 10, wherein the system is designed to be compatible with multiple vehicle makes and models, allowing for universal application in aftermarket modifications.

14. The method of claim 10, wherein the bumper lift system maintains the functionality of auxiliary bumper components, including tow hooks, crash sensors, and grille guards.

15. The method of claim 10, wherein the installation process does not require welding, cutting, or permanent modifications to the vehicle's frame.
